(19) United States
(12) Patent Application Publication
(10) Pub. No.: US 2003/0070170 A1
(43) Pub. Date: Apr. 10, 2003

(54) Method and apparatus providing an improved electronic program guide in a cable television system

(76) Inventor: Eric Lennon, Amsterdam (NL)

Correspondence Address: HARRINGTON & SMITH, LLP, 4 RESEARCH DRIVE, SHELTON, CT, 06484-6212, US

(21) Appl. No.: 10/115,649

(22) Filed: Apr. 3, 2002

Related U.S. Application Data
(60) Provisional application No. 60/317,919, filed on Sep. 7, 2001.

(51) Int. Cl. G06F 3/00; H04N 5/445; G06F 13/00; H04N 7/173

(52) U.S. Cl. 725/51; 725/48; 725/112; 725/110

(57) ABSTRACT

An Electronic Programming Guide (EPG) is implemented as an Interactive Entertainment Guide (IEG) that enables a subscriber to interact with a database containing programming schedule and other information over a bidirectional communication link provided between the subscriber's set top box (STB) and the IEG source or server at the cable system head-end, or at some other location. This invention provides an advanced cable television system having an IEG presentation subsystem that comprises a head-end database for storing programming information for a plurality of cable channels, and an internet protocol (IP)-based Web browser function in each television STB for receiving and displaying the programming information in a list format, and for providing interactivity with the head-end via a bidirectional data link.

### CROSS-REFERENCE TO RELATED APPLICATION

This application claims the benefit under 35 U.S.C. §119(e) of U.S. provisional patent application No. 60/317,919 which is hereby incorporated by reference in its entirety.

### BACKGROUND OF THE INVENTION

1. Field of the Invention

These teachings relate generally to the cable-based distribution of programming to subscribers and, more specifically, relate to an electronic program guide (EPG) that is provided to the subscribers for describing the programming and the scheduling of the programming.

2. Brief Description of Prior Developments

The use of Electronic Program Guides (EPGs) in cable television systems is well known in the art. Reference can be made, by example, to U.S. Pat. Nos. 6,072,460; 5,585,866; and 5,592,551 for describing various types of EPGs and methods for using same.

In that the EPG is a very visible and often used subscriber user interface, it can be appreciated that it is important and desirable to make the experience of using the EPG as simple and as informative as possible. A problem may be presented to the cable system operator if the EPG fails to meet these goals.

### SUMMARY OF THE INVENTION

The foregoing and other problems are overcome by methods and apparatus in accordance with embodiments of these teachings.

The teachings of this invention pertain to an EPG implemented as an Interactive Entertainment Guide (IEG) that enables a subscriber to interact with a database containing programming schedule and other information over a bidirectional communication link provided between the subscriber's set top box (STB) and the IEG source or server at the cable system head-end, or at some other location.

This invention provides an advanced cable television system having an interactive entertainment guide presentation subsystem that comprises a head-end database for storing programming information for a plurality of cable channels, and an internet protocol (IP)-based Web browser function in each television STB for receiving and displaying the programming information in a list format, and for providing interactivity with the head-end via a bidirectional data link.

In accordance with one aspect of the present invention, a television interactive entertainment guide display system is provided for displaying television channels, broadcast program titles, and broadcast times on a television display screen. The system is adapted to display on the television display screen a vertically arranged list of the broadcast program titles, the list having only a single column of the titles organized and displayed adjacent respective associated broadcast times in a vertically arranged time sequence, wherein the list is limited to only a predetermined user selected channel.

In accordance with another aspect of the present invention, a television interactive entertainment guide display system is provided for displaying television channels, broadcast program titles, and broadcast times on a television display screen. The system is adapted to display a list of the television channels and subsequently display a first type of sub-list for a selected one of the channels, the first type of sub-list comprising a vertical column array of the broadcast program titles and associated ones of the broadcast times for the channel or, alternatively, the system being adapted to display a list of the broadcast times and subsequently display a second type of sub-list for a selected one of the broadcast times, the second type of sub-list comprising a vertical column array of the television channels and associated ones of the broadcast program titles, wherein the titles are displayed in only a single vertical column on the television display screen in a predetermined sequential order along the column.

In accordance with one method of the present invention, a method for selecting a broadcast television program, the program being broadcast based upon broadcast limitations comprising a broadcast channel and a broadcast time, is provided comprising steps of entering a first one of the broadcast limitations into a broadcast television program selector; upon entering the first broadcast limitation, displaying a list of a second one of the broadcast limitations, corresponding to the entered first broadcast limitation, in a vertical array on a screen of the television, the list being arranged adjacent a single column of program titles corresponding to the broadcast television programs for the vertically displayed second broadcast limitations and the entered first broadcast limitation; and selecting one of the program titles in the single column of program titles by vertically moving a stepwise vertical only moving cursor/highlighter.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is an overall simplified system diagram of a cable television system in accordance with these teachings;

FIG. 2 is a more detailed block diagram of the system shown in FIG. 1;

FIG. 3 is a diagram showing the construction of one of the regional hubs depicted in FIG. 2;

FIG. 4 is a process flow diagram that is useful when explaining a “walled garden” approach to providing Internet Web page access to subscribers of the cable television system;

FIG. 5 is a process flow diagram that shows a technique for providing an e-mail service to subscribers of the cable television system;

FIG. 6 is a process flow diagram that shows a technique for providing an Internet chat service to subscribers of the cable television system;

FIG. 7 is a diagram illustrating EPG data delivery;

FIG. 8 is a depiction of an embodiment of the STB software architecture;

FIG. 9 shows an example of one type of EPG multi-layer window display configuration using a list format;

FIG. 10 is an example of a first type of first layer display window of the multi-layer window display configuration of FIG. 9;

FIG. 11 is an example of a first type of a second layer display window of the multi-layer window display configuration of FIG. 9;

FIG. 12 is a top plan view of a user television/program selector remote control;

FIG. 13 and shows an example of another type of EPG multi-layer window display configuration using a list format;

FIG. 14 is an example of a second type of first layer display window; and

FIG. 15 is an example of a second type of second layer display window.

### DETAILED DESCRIPTION OF THE PREFERRED EMBODIMENTS

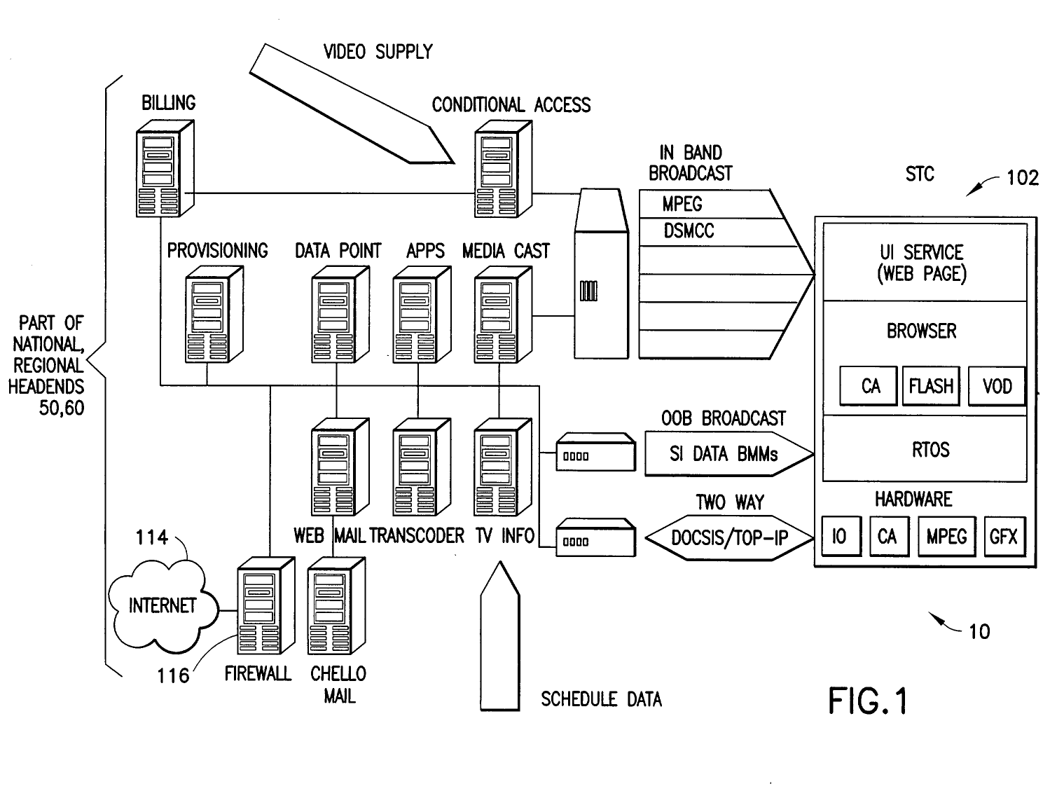

Referring to FIG. 1, in a preferred embodiment of a cable provider system 10 an IEG user or subscriber interface runs on a set-top computer (STC) 102 as a Web Browser. The STC 102 may be referred to herein interchangeably as a set-top box (STB) 102. One suitable, but not limiting, Web Browser is provided by Liberate, and is known as the TV Navigator™. This software may be referred to as STC middleware. The IEG application itself is preferably written in HTML and JavaScript, both of which are well known to those skilled in the programming arts, and is stored in STC memory, preferably in flash memory. HTML and JavaScript applications may also be retrieved from servers at the head-end (50, 60), or from servers on the Internet 114.

The above-referenced Liberate TV Navigator software differs in several salient respects from PC-based Web browsers such as Microsoft Internet Explorer™. For example, and with regard to TV Schedule Data, TV Navigator incorporates additional APIs (Application Programming Interfaces) to allow an application, such as the IEG, to access TV Schedule data and the data required to facilitate control of the television viewing experience. The software also enables TV viewing control and conditional access by providing the controls required to allow channel tuning, scaling and positioning of a video window. Controls are also provided to allow the purchase of conditional access events and, thus, facilitates Pay-Per-View (PPV) and Video-on-Demand (VOD) services. With regard to Navigation Controls it also provides control over the movement of a bounding box (selection box) on the TV screen so that the user can navigate the interface without requiring use of a mouse. Typically the user will employ a wireless remote control device to interact with the STC 102.

A STC 102 and HFC (Hybrid Fiber Coaxial cable) network provide additional capabilities which are not available to a computer-based browser. These include an In-Band Broadcast data path having a large bandwidth. In the preferred embodiment the In-Band Broadcast data path has the capacity to simultaneously deliver broadcast data for up to 200 digital television channels. In alternate embodiments, the data path could be adapted to deliver more or less than 200 channels. The channels (services) are preferably packaged into multiplexes (containing about 10 channels each), and the STC 102 operates to decode data from a single multiplex at a time. However, in alternate embodiments, the channels could be packaged in any suitable fashion. A given channel/service can contain broadcast video and/or audio and/or data, or any combination of these. In a preferred embodiment, the broadcast data is sent using a DSM-CC protocol. Also in a preferred embodiment, MPEG data can be sent as well over the In-Band Broadcast data path. However, in alternate embodiments, the broadcast data and the MPEP data could be sent over any suitable path and/or protocol. Using this capability, the STC 102 and TV Navigator can decode DVB-SI. DVB is a well-known European standard for digital television data delivery.

The STC 102 preferably comprises a second broadcast data path that is referred to as an Out-of-Band (OOB) data channel. The Out-of-Band data channel is used for the delivery of the cable provider's own schedule data and other system data. The Out-of-Band data channel may duplicate, to some extent, the DVB-SI data delivery mechanism.

The STC 102 can also incorporate a two-way data path that preferably operates in accordance with a DOCSIS standard. The DOCSIS two-way path is somewhat analogous to a PC Ethernet connection. The DOCSIS two-way path provides support for the universal networking protocol known as TCP-IP that underlies the operation of the Internet. The two-way data path facilitates interactive services by using TCP/IP protocols. The DOCSIS two-way path terminates in a cable modem that forms a part of the STC 102. A PC could therefore use the STC 102 as a broadband modem for accessing the Internet 114.

In the current state of the art, the STC 102 is more constrained in the amount of memory available for running applications and loading Web pages than is a conventional PC. For example, and unlike Internet Explorer™ running on the Windows™ operating system, the STC 102 does not define or present any user interface (UI) for filing (files, folders, explorers), Navigation (Windows, desktops or start menus), or maintenance (accessory applications). For the user to have the capability of entering a Web address, or selecting a favorite site to visit, a user interface, allowing access to the functionality, is provided separately in HTML and JavaScript.

In the preferred embodiment of the IEG, a user interface application written in HTML and JavaScript can run on top of the TV Navigator Web browser. The IEG can allow, amongst other things, interaction with the television, browsing of program listings (schedule data), purchase of TV on-demand events, and control over the STC 102 and video options. Due in large part to the constraints imposed by the capabilities and resources of the Web Browser (e.g., the Web Browser may support button-based navigation only), the IEG is preferably constructed so as to provide navigation via Remote Control buttons (e.g., a mouse pointer need not be not supported). However, even when working within the constraints of the Web Browser (the capabilities of which are in turn constrained by the underlying hardware system, network, data and media assets) a rich variety of innovative application functionality and user look and feel functionality can still be provided. Because at present time there is no standard operating system-level user interface for digital television services (e.g., there is no equivalent of Microsoft Windows computer operating system for a TV/STC operating system), all displayed information on the TV screen needs to be furnished by the cable TV operator.

The presently preferred, but not limiting, Liberate software is a distributed platform. A distributed platform means that certain of the processing required by the applications running on the STC 102 is executed both on the client (in this case the STC 102) and on one or more servers in the head-end 50, 60. For example, when the TV Navigator loads and processes HTML pages for display on the TV screen, the TV Navigator does not do so directly from the Web server storing the pages. Instead, the pages are first loaded into a transcoding server function (124A, 124B) for error checking and compacting. Then, from the transcoding server function (124A, 124B), the pages are sent on to the client (i.e., the STC 102). This pre-processing by the transcoding server function means that the client (the STC 102) does less work in displaying the pages. Thus, the client (i.e., the STC 102) requires less memory.

The application software can also interact in various ways with the back-end servers, such as provisioning servers. Thus, provisioning services can be provided. User management and system management/VOD catalogue management services can also be provided.

Having provided an overview of the STC 102 and its functionality, a discussion will now be undertaken of the EPG (Electronic Program Guide) server. The major purpose of the EPG server is to store the program schedule(s) for all services/channels that are broadcast. The schedule information is used for signal scrambling, conditional access control, DVB data table generation and EPG information on the STB 102. The EPG database can also function as a configuration repository for many of the head-end systems which the EPG database interfaces with. This can include service lineup per head-end, service data stream components (video, audio, subtitling etc.) and network connectivity information for each system. The information can be used by the EPG database to facilitate schedule delivery to the relevant systems in a dynamic manner.

In a preferred embodiment, the EPG database is implemented based on a Microsoft platform. More specifically, the EPG database can run on Microsoft SQL (Structured Query Language) Server RDBMS on a Microsoft Windows 2000™ Advanced Server, allowing for failover redundancy with 2-server clustering technology. An operator graphical user interface (GUI) can be implemented with Microsoft Visual Basic™ and export modules to the head-end systems with Microsoft Visual C++. The import modules can be implemented with SQL Server Data Transformation Packages (DTS). The internal database validation and export logic can be implemented with SQL Server Transact-SQL stored procedures. The external API can also be made available as Transact-SQL stored procedures.

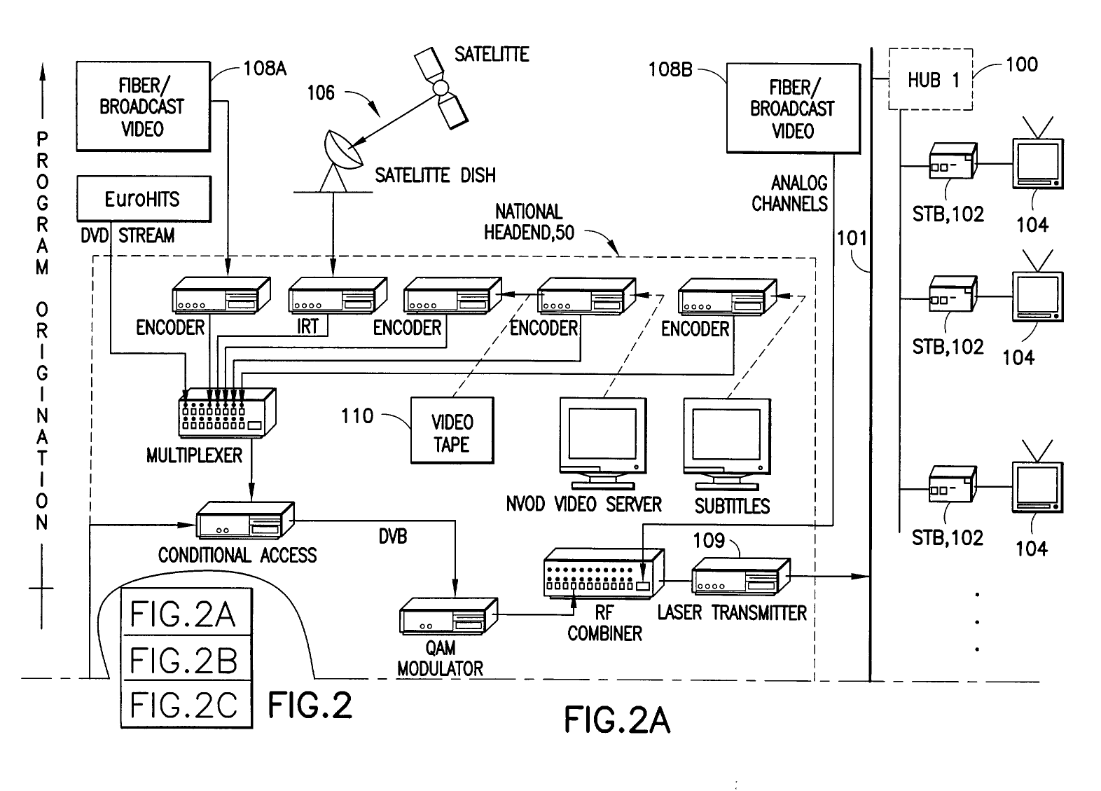

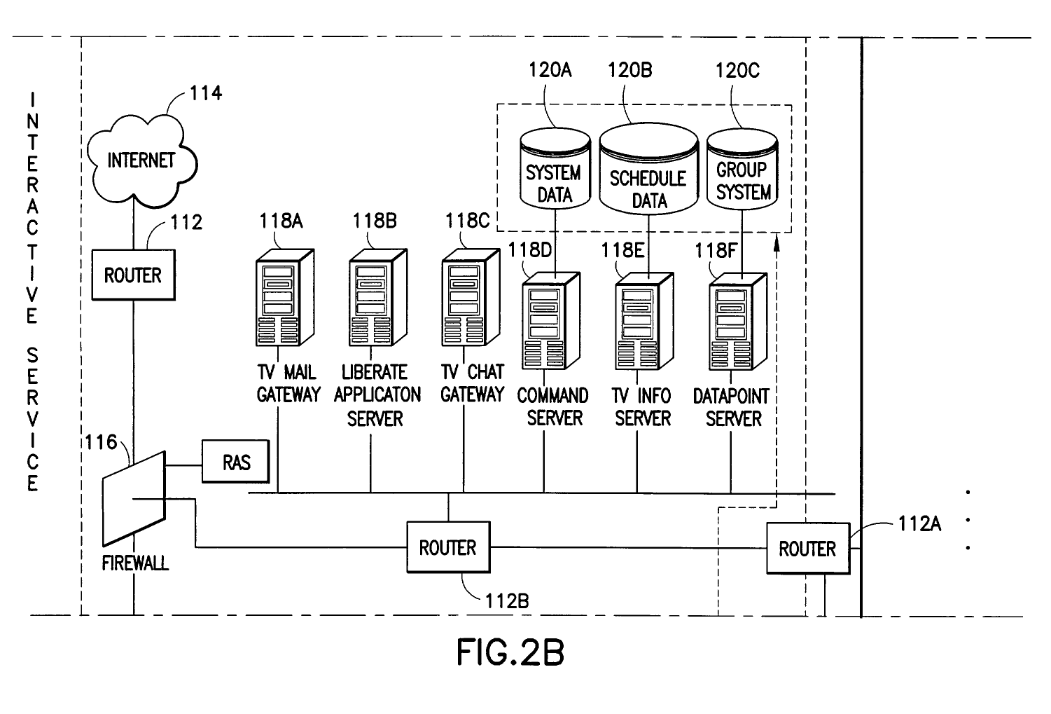

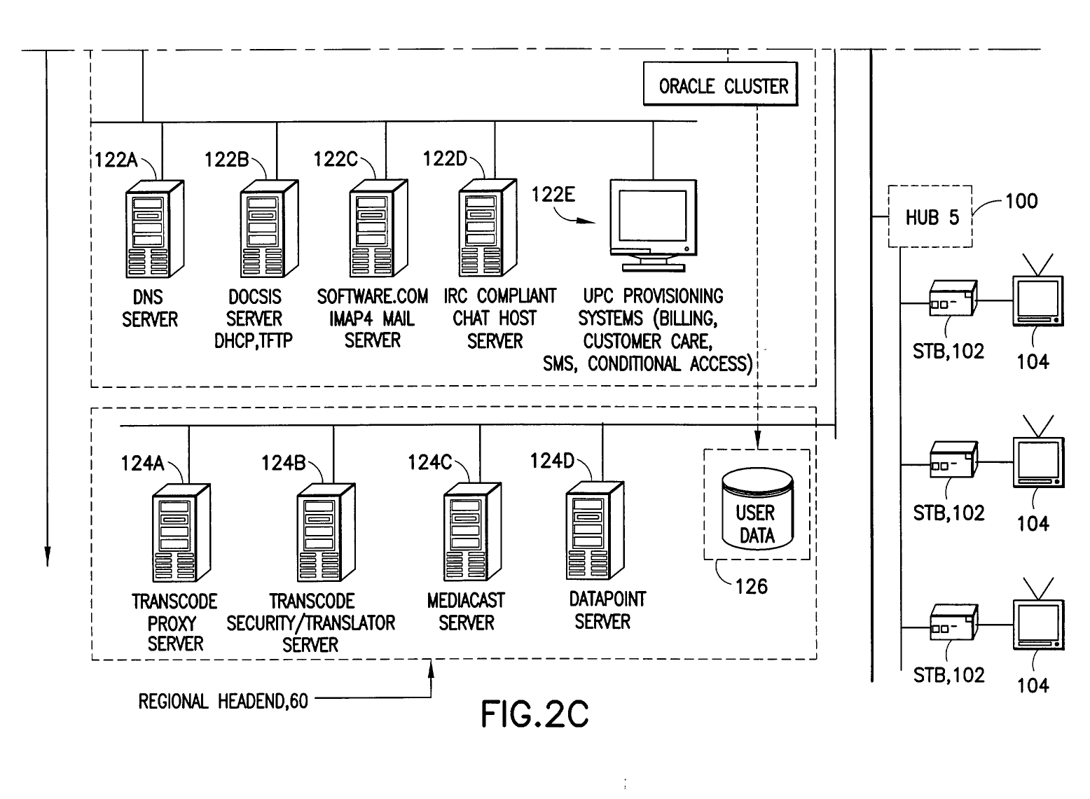

In a preferred embodiment, the cable TV provider is capable of operation in different countries or regions. When the cable TV provider operations in different countries or regions, each country or region may have an EPG database 120B installed in the national head-end 50 for that country/region (see FIG. 2). The installation can include a plurality of data processors, such as three Intel-based machines running Microsoft Windows 2000 Advanced Server, for example. Two of these machines act as the clustered SQL Server platform, while the third machine can function as a staging server that listings providers can connect to; from a dial-in line, for example. The listings providers can supply the programming-related information that is stored in the EPG database 120B. More particularly, the listings providers can supply schedule files in a specific format that can be read by the EPG Server. These files can be delivered to a provider-specific file system directory on the staging server. The directory can be polled at regular intervals by the EPG Server import process. The presence of a new file can be detected and, the file can then be transferred to the main EPG server for further evaluation and processing.

The schedule files can adhere to a specific format that is verified by an import process. Once this is done the content of the files can be loaded into a separate staging area in the database. In the staging area, a thorough examination of the new data can be performed. Any new or changed schedule information can then be detected. The EPG database can examine these changes and determine which operations are required to be performed in order to update the interfaced head-end systems. New export data may be generated for this purpose; perhaps for later processing by separate export functions.

In a preferred embodiment, the schedule information and head-end configuration information can be stored in a normalized relational database. This can allow for extremely flexible and powerful reporting and manipulation using SQL. The EPG database 120B can support any number of concurrent languages for event descriptions.

Since all of the relevant information for schedule delivery to head-end systems is stored in the EPG database 120B, the database has the capability to distribute schedule events to each head-end system. The database has the capability to keep track of the status of each single event on all systems. The actual transmission of the schedule data is preferably done by a process external to the database. However, this external transmission process can be responsible for reporting back progress and final status for all events that are exported. In the preferred embodiment, standardized connectors can be provided to interface the EPG database 120B with other software systems. For example, standardized connectors can be provided to interface the EPG database 120B with billing systems and conditional access systems (122E). In addition, direct connection interfaces can be provided from the EPG database server 118E to other custom software systems. The EPG server 118E can have built-in capabilities of creating schedule events for any number of services for any time period.

In order to provide an operator with a user interface, a separate Windows application is preferably provided to access and monitor all of the data in the EPG database 120B. This user interface can include easy-to-use maintenance of all the configurable parameters including services, head-ends, head-end channel lineups, head-end systems, program categories, subcategories and types. In the preferred embodiment, the user interface also includes a graphical schedule viewer giving the user visual feedback on the export status to all systems in the head-end. Manual data import and export, as well as database backup and maintenance functions are also preferably available.

The EPG database 120B preferably has a SNMP-based monitoring system that can be integrated with existing system management systems in the head-end. This allows ready detection of error situations, such as a lack of schedule information or errors in the export to any system.

In a preferred embodiment, the STC middleware supports e-mail, browsing to a “walled garden”, broadcast television, impulse pay-per-view, teletext, digital music channels, auto provisioning, chat and the HTML-based EPG, Video On Demand, Open Internet browsing, as described in further detail below. The STC middleware could also support other services, such as Video on Demand, Open Internet Browsing, or any other suitable television/Internet related service. The “walled garden” content is preferably accessed through the Internet 114 via a firewall 116, and the accessible pages are controlled in accordance with a list of acceptable pages.

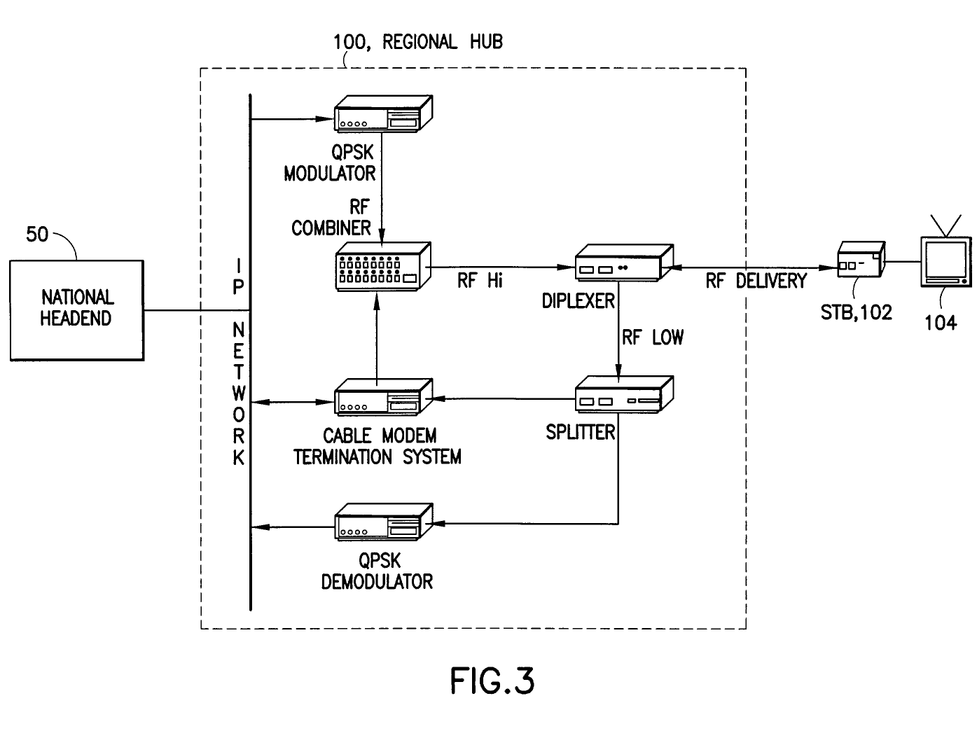

FIG. 2 shows an embodiment of the national head-end 50 architecture as well as the regional head-end 60 architecture. A number of regional hubs 100 (see FIG. 3 as well) are interconnected via a high-speed digital network, preferably a fiber optic cable 101. Each regional hub 100 is connected to a number of subscriber STBs 102 and associated televisions 104. Programming can be provided from a satellite system 106, or from a fiber/broadcast video system 108A, 108B, or from tape 110, or from any suitable source of programming. Various known types of encoders, multiplexers and RF combiners can be used to supply the programming to the STBs 102 via a laser transmitter 109, the network 101 and hubs 100.

Also connected to the network 101 are one or more routers 112A, 112B that provide access to the Internet 114 via the firewall 116. The router 112B provides access to a plurality of servers and gateways including, by example, a TV mail gateway 118A, an application server 118B, a TV chat gateway 118C, a command server 118D, a TV information (info) server 118E and a datapoint server 118F. The command server 118D has an associated system database 120A, the TV info server has the associated IEG schedule database 120B, and the datapoint server 118F has an associated group system database 120C. Also provided at the national head-end 50 can be various other servers 122, such as a Domain Name Server (DNS) 122A, the above-mentioned DOCSIS server 122B, a mail server 122C, a chat host server 122D, and various provisioning-related systems and subsystems 122E, such as billing, customer care and conditional access subsystems.

The regional head-end 60 can include a transcode proxy server 124A, a transcode security/translator server 124B, a mediacast server 124C and a datapoint server 124D having an associated user database 126. Transcoding is useful and preferred for converting Web content to a common format that is optimized for television screen display. For example, JPEG, GIF and BMP files can be converted to XNG and its superset WNG files. Sound files and HTML can be passed through the transcode mechanism. It should be appreciated that the specific architecture shown in FIG. 2 is exemplary and illustrative. The specific architecture shown in FIG. 2 is not to be construed in a limiting fashion upon the practice of this invention. FIG. 3 shows in greater detail the architecture of the regional hub 100 head-end architecture, and the connection between the national head-end 50 of FIG. 2 and the STB 102 via an Internet Protocol (IP) network.

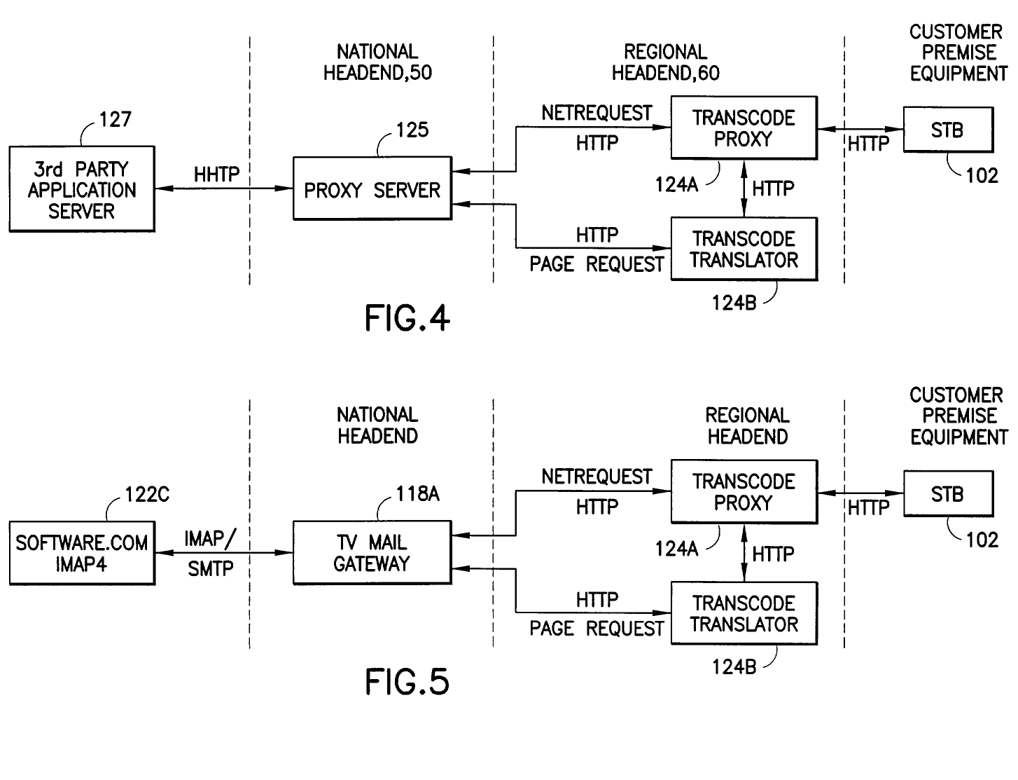

Referring also to FIG. 4, the above-mentioned “walled garden” is preferably comprised of a restricted set of HTML Web pages. The walled garden can be used by the cable operator to restrict subscribers to certain Web sites. One advantage of the walled garden is that the Web site content can be developed specifically for the operator. Another advantage is that the content can be co-hosted by third party Web servers 127 that are not co-located with the head-end. This can conserve head-end space and data processing requirements.

The content of the walled garden Web sites can be hosted on an internal Web server. Therefore, all content can be maintained locally. An advantage of this is that all content can be pre-transcoded in advance. This can enable rapid display by the STB 102. Alternatively, the static content can be hosted locally (and pre-transcoded). In this alternative, the dynamic content can be accessed directly from the Internet 114 via the firewall 116. In a further embodiment, a proxy server 125 can be used to access pages directly from the Internet 114, such as through the use of a list of allowed Web pages. Because no internal Web content server is required in this latter embodiment, maintenance by the cable system operator can be significantly reduced because the external content providers 127 would be responsible for developing and maintaining the Web pages. The walled garden process flow is shown in FIG. 4.

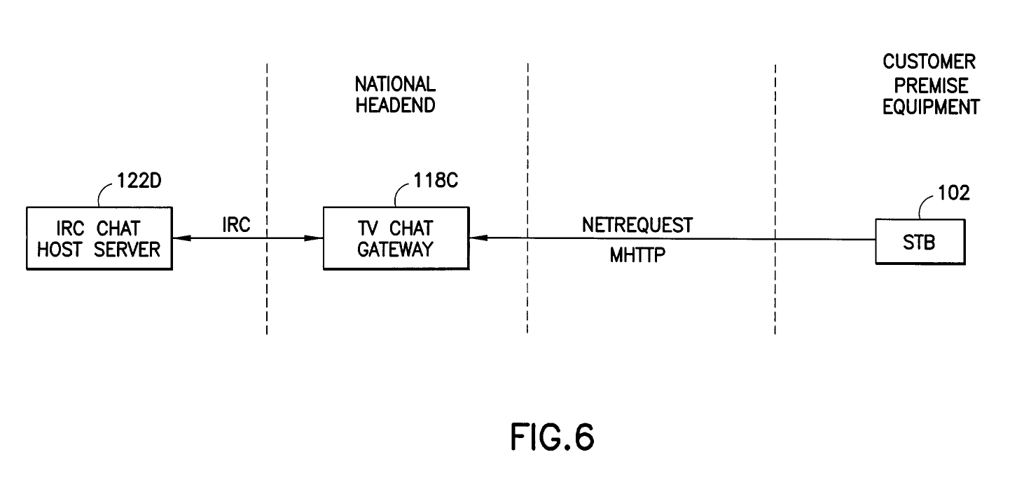

The system 10 can also provide the above-mentioned TV e-mail and TV chat functions, the process flows of which are shown in FIGS. 5 and 6, respectively.

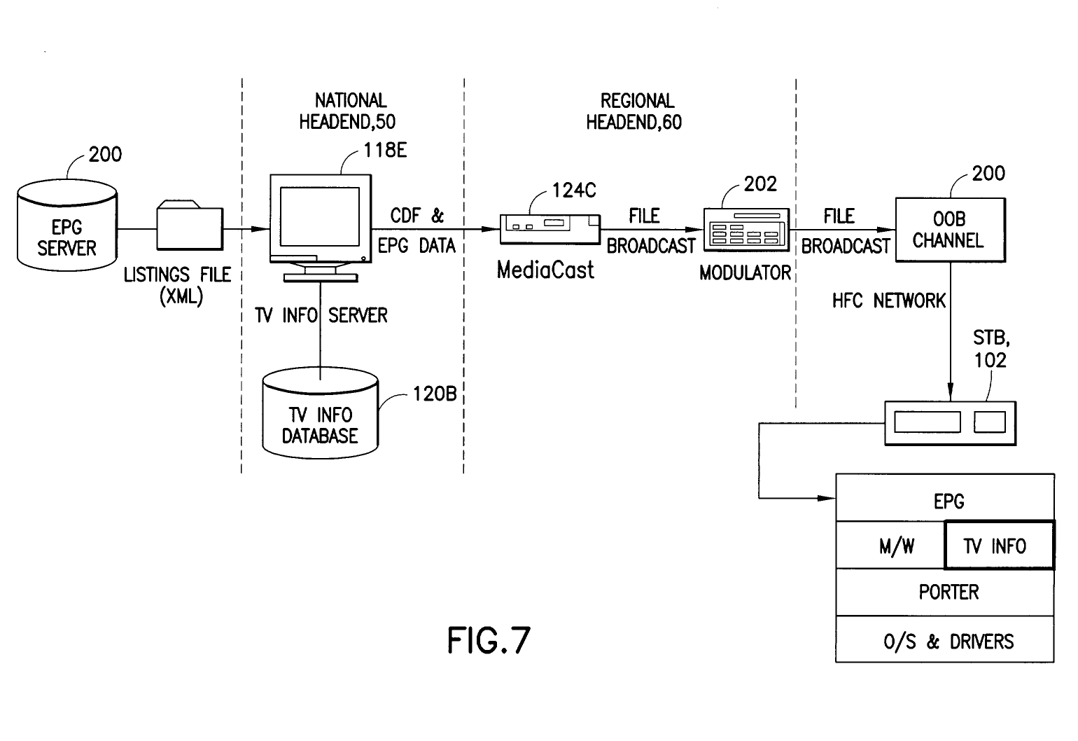

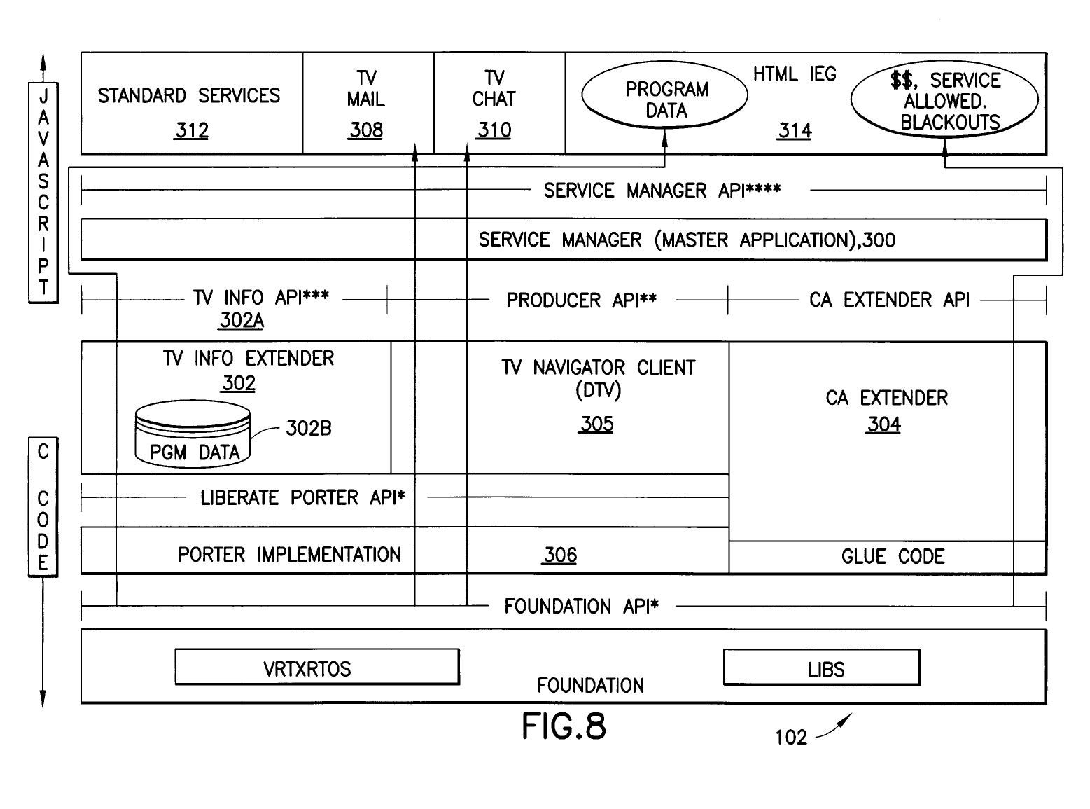

FIG. 7 illustrates the delivery of IEG data from the EPG server 200 to the STB 102. The EPG server 200 contains schedules from listings provided by programmers. The listings would include program titles. A listings file (XML) is provided to the TV info server 118E for storage in the TV info database 120B. However, the listings could be in any suitable format or location for eventual transmission to the STB 102. This data is sent to the mediacast server 124D of the regional head-end and is file broadcast via a QPSK modulator 202 (e.g., a Motorola QPSK modulator (OM 1000)) to the OOB RF carrier channel and thence to the STB 102. The STB 102 software architecture (see also FIG. 8) includes the EPG layer, an underlying STB middleware (M/W) layer and TV info layer, a porter layer and the bottom-most or foundation operating system (O/S) and hardware drivers layer. In one (non-limiting) embodiment the STB 102 is manufactured by Motorola (DVI5000), and the porter and foundation layers are C code programs, as may be the overlying TV info extender (client), TV Navigator client and Conditional Access (CA) extender programs. The overlying service manager (master application) and standard services, TV mail, TV chat and HTML IEG software modules are preferably JavaScript programs.

As was discussed previously, the STB 102 includes, in the presently preferred embodiment, the Liberate TV Navigator software. In this preferred embodiment the TV Navigator software supports standards-based HTML and JavaScript implementations for developing TV applications using standard Web-authoring tools. Various extensions may provide embedded video in a Web page, the ability to tune a TV channel from a JavaScript application, the control of network communications and the management of multiple users on set-top boxes.

FIG. 8 is a depiction of a non-limiting embodiment of the STB 102 software architecture. The service manager 300 provides the operational framework for the STB 102 services, and implements system-level event handlers among other functions. A service declares itself to the service manager 300 via a Service object (e.g., what type of service, the name to be displayed for the service, whether the service is required or optional, etc.)

The TV info client 302 is responsible for extracting the IEG data from the OOB data stream and storing the extracted IEG data into a memory of the STB 102 (shown as Program (PGM) Data 302B). The mediacast server 124D at the regional head-end 60 uses data carousels to access the IEG data from the national head-end 50 (see FIG. 2). This data is subsequently injected into the OOB broadcast data stream that is routed to the regional head-end 60, as was described above.

The conditional access (CA) extender 304 allows the binding of DVB descriptors to JavaScript API's or method call and callbacks, and enables new descriptors to be added to the DVB stream.

Also provided are a TV porter 306 that provides the APIs necessary to run the TV Navigator client middleman code which in turn supports the unique requirements of higher level services such as the TV mail client 308 and the TV chat client 310. The standard services 312 are those that are required to provide the essential tasks of the user interface, including by example changing channels, displaying a status bar, providing Web access, and maintaining a record of favorite channels and Web sites.

The TV Navigator 305 runs the IEG 314, which communicates with various parts of the STB 102 system. In order to display the programming schedule information to the subscriber the IEG 314 registers with the service manager 300 as a Window type of service, and for processing remote control button inputs it registers as a Key type of service. In order to access the IEG data it makes calls directly into the TV Info API 302A which has, in turn, cached the IEG program data (PGM 302B) that was delivered through the OOB channel.

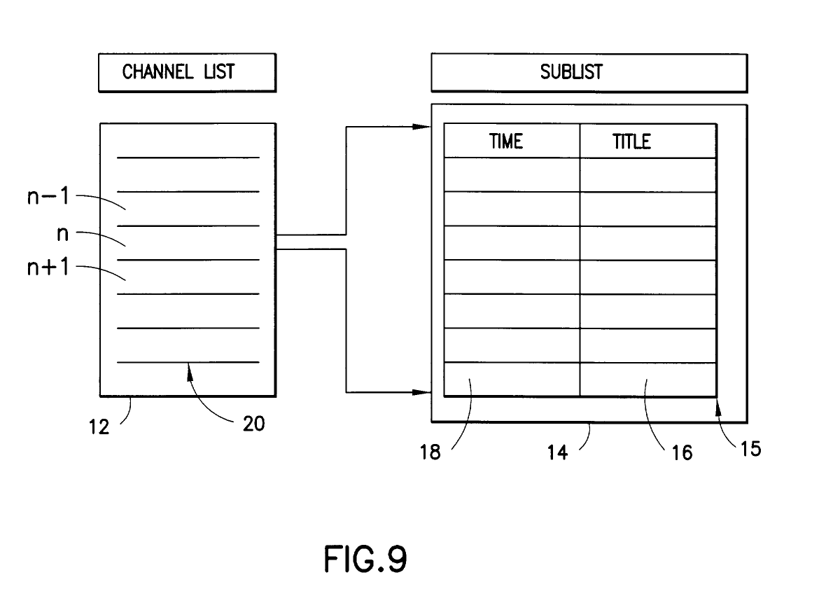

In prior applications, interactive entertainment guides (IEGs) were displayed on a television screen in the form of program titles arranged as a grid of channels and times. In the conventional grid format, one axis (e.g., the x-axis) represents time in fixed increments of, typically, one half hour, while the other axis represents the various cable channels. In the preferred embodiment of the present invention, the IEG is displayed in the form of a list. FIG. 9 shows an example of the list presentation of the EPG (electronic program guide) portion of the IEG. The list presentation technique does not suffer from the time boundary constraints found in the conventional grid format.

The EPG in this embodiment generally comprises a multi-layer window display configuration using a list format in the windows. In the embodiment shown, the EPG comprises a two-layer 12, 14 window display configuration. However, in alternate embodiments, the EPG could comprise more or less than two layers. In this embodiment, the first layer 12 generally comprises a channel list 20 which is displayed on the television screen. The channel list 20 preferably lists the channels in numerical or alphabetical order. The channels are preferably organized in an array of at least one column. When a user selects one of the channels on the channel list 20, such as channel “n”, the EPG then automatically switches to the second layer 14 being displayed on the television screen.

The second layer 14 generally comprises a sub-list 15 comprising program titles 16 and corresponding broadcast times 18 for the programs corresponding to the program titles. The schedule in the sub-list 15 is specifically for the channel “n” selected by the user. If the user selected a different channel, then the sub-list 15 would list the program titles and broadcast times for the broadcast programs that are intended to be displayed on that different channel. The sub-list 15 is preferably for a predetermined period of time, such as 4-6 hours. However, the predetermined period of time could be any suitable time interval. The predetermined period of time could also be varied by the user. A user could also possibly scroll or move outside the times shown in the sub-list. For example, a user could perhaps move the schedule shown in the sub-list 15 to show programs and times for a day other that the present date.

In one type of alternate embodiment, the two layers 12, 14 could be displayed on the television display screen at a same time. The titles displayed in the sub-list 15 would change depending upon which channel in the channel list 20 was marked or highlighted by a cursor. The user could switch the cursor between the channel list 20 and the sub-list 15 to expand or move the show times 18 and corresponding titles 16 for expanding or moving the shown times 18 and titles 16 for the selected or highlighted channel in the channel list 20.

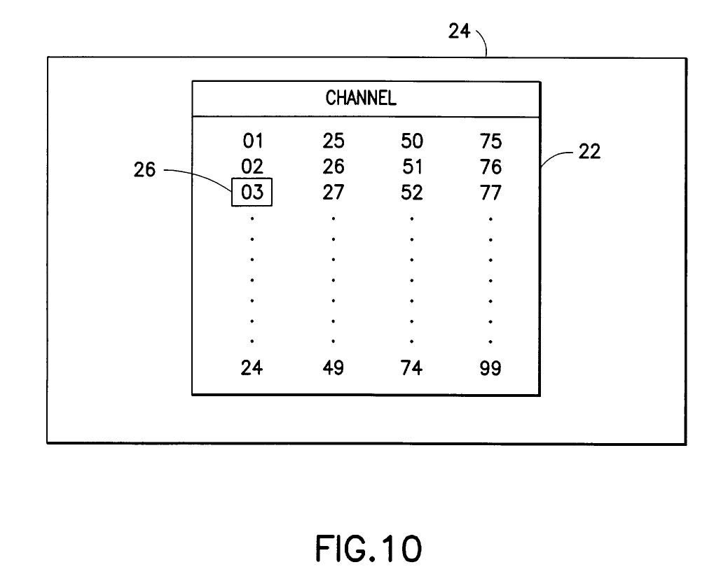

Referring now also to FIG. 10, a first type of first layer display window 22 of the multi-layer window display configuration of FIG. 9 is shown on a television display screen 24. In this embodiment, the first layer display window 22 comprises the list 20 of the channels. The first layer display window 22 may comprise a plurality of windows which can be flipped through by the user. The user can move a cursor/highlighter 26 onto one of the channel numbers and press a selector button, such as on a remote control or on the set top box 102, to select that channel.

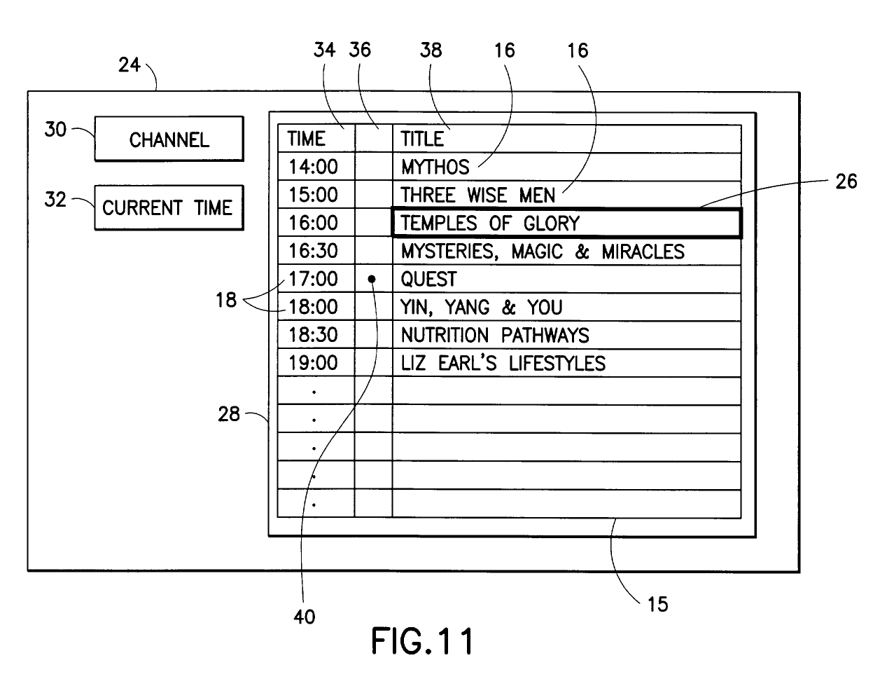

Once the user selects the channel from the first layer display window 22, the display on the television screen 24 automatically switches to the second layer display windows 28, 30, 32 as shown in FIG. 11. The first window 28 forms a window for displaying the sub-list 15. The second window 30 forms a window for displaying the channel number selected in the first layer window 22. The third window 32 forms a window for displaying the current time on the television screen 24. In an alternate embodiment, more or less display windows could be in the second layer. For example, in an alternate embodiment, the current time window 32 and the channel window 30 might not be shown. In another alternate embodiment, an additional date window might be shown.

The sub-list 15, in the embodiment shown, generally comprises three columns of information 34, 36, 38. The third column 38 displays titles 16 of broadcast programs for the channel shown window 30. The first column 34 displays the broadcast start times 18 corresponding to the associated program titles 16 to their right. The middle column 36 can be provided to allow a marker 40 to be placed at a time and program titles to indicate a predetermined information, such as a memo, or that the program has previously been requested or is intended to be recorded. However, in an alternate embodiment, the middle column 36 might not be provided.

Also displayed on the window 28 is the cursor/highlighter 26. The cursor/highlighter 26 is adapted to vertically move up and down the column 38 of titles 16. When the cursor/highlighter 26 is located at a title, the user can select the title for viewing or other programming by pressing a selector button on the set top box 102 or a remote control. The cursor/highlighter 26, while in the window 28, is preferably adapted to only vertically move up and down along the column 38 of titles 16.

As noted above, the system could comprise a single layer configuration. For example, the system could merely comprise the layer shown on the screen in FIG. 11. In this alternate embodiment, the user could enter the channel at window 30 and the window 28 would change to the selected channel. The system could initially default to the current channel being viewed for the channel window 30. The cursor/highlighter 26 could be toggled to switch between the two windows 28, 30 by any suitable toggling system. The window 30 could also have a drop down feature, for viewing multiple channel numbers at a same time, with the window 30 expanding when the cursor/highlighter is located in the window 30. Thus, the present invention does not need to be used in only a multi-layer window configuration.

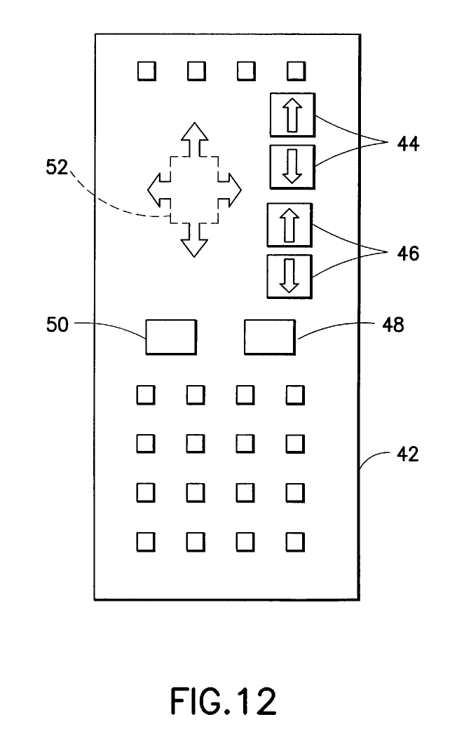

Referring now also to FIG. 12, a top plan view of a remote control 42 is show. The remote control 42 is conventional to the art. The remote control 42 includes buttons 44 for controlling volume, buttons 46 for controlling cursor movement and channel selection, a selector button 48, a menu button 50, and perhaps a multi-axis navigation button 52. The multi-axis navigation button 52 might not be provided. Alternatively, the multi-axis navigation button 52 could be provided to replace the buttons 44, 46; their functions being supplied by the multi-axis navigation button 52.

In order to get to the first layer shown in FIG. 10, a user could depress the menu button 50 on the remote control 42. In an alternate embodiment, any suitable type of system for accessing the first layer could be provided. When the EPG is located at the first layer shown in FIG. 10, the user can move the cursor/highlighter 26 to a desired channel number only by depressing one of the up and down arrow buttons 46. Once the cursor/highlighter 26 is moved to the desired channel, the user can depress the selector button 48. The EPG then moves to the second layer shown in FIG. 11. In an alternate embodiment, any suitable system for selecting the highlighted channel could be provided. At the second layer shown in FIG. 11, the user can move the cursor/highlighter 26 to a desired title 16 only by depressing one of the up and down arrow buttons 46. The cursor/highlighter 26 is moved to the desired title, the user can depress the selector button 48 to select the program title.

One of the attributes of the present invention is the ability to use a very simple remote control 42 which comprises simple up and down buttons 46 for navigating through the EPG. With the present invention, a new type of remote control is not necessary to navigate through the EPG. Pre-existing remote controls, which can number in the tens of millions, already located in households, can be used to practice the present invention. There is no need to replace these pre-existing, pre-positioned remote controls with any type of new remote control. This is an obvious cost savings to a television operator (such as a cable television operator).

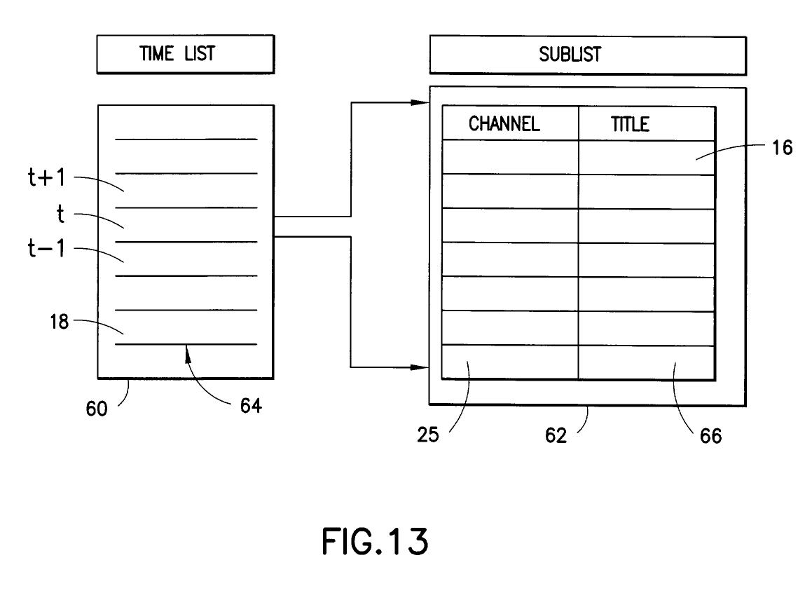

Referring now to FIG. 13, an alternate embodiment is shown. In the embodiment shown, the EPG comprises a two-layer 60, 62 window display configuration. However, in alternate embodiments, the EPG could comprise more or less than two layers. In this embodiment, the first layer 60 generally comprises a time list 64 which is displayed on the television screen. The time list 64 preferably lists program broadcast times in order; such as by half hour increments. When a user selects one of the times on the time list 64, such as time “t”, the EPG then automatically switches to the second layer 62 being displayed on the television screen.

The second layer 62 generally comprises a sub-list 66 comprising program titles 16 and corresponding broadcast channels 25 for the programs corresponding to the program titles. The schedule in the sub-list 66 is specifically for the time “t” selected by the user. If the user selected a different time, then the sub-list 66 would list the program titles and channels for the broadcast programs that are intended to be displayed at that different time. The sub-list 66 is preferably for a predetermined set of channels, such as a preferred “favorites” set of channels; pre-selected selected by the user. However, the predetermined channels could be any suitable channels, including all the channels. A user could also possibly scroll or move outside the channels shown in the sub-list. For example, a user could perhaps move the schedule shown in the sub-list 66 to show programs for additional channels on a sequentially following window screen.

In one type of alternate embodiment, the two layers 60, 62 could be displayed on the television display screen at a same time. The titles displayed in the sub-list 66 could change depending upon which time in the time list 64 was marked or highlighted by a cursor. The user could switch the cursor between the time list 64 and the sub-list 66 to expand or move the channels 25 and corresponding titles 16 for expanding or moving the channels 25 and titles 16 for the selected or highlighted time in the time list 64.

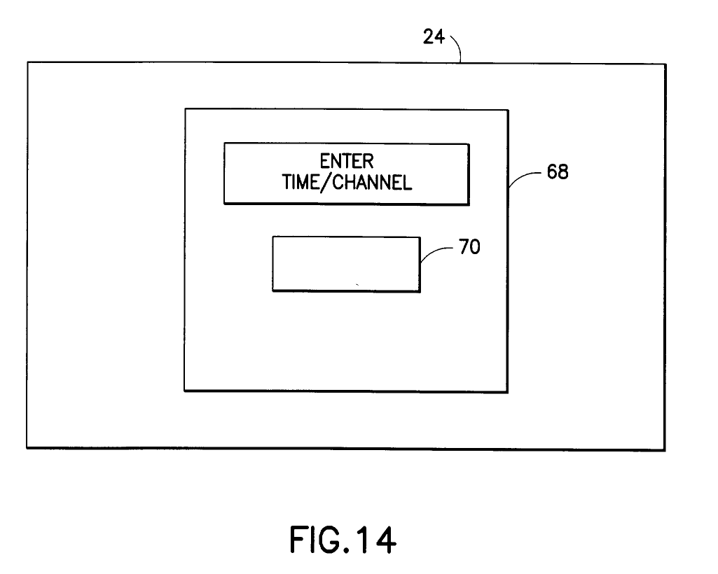

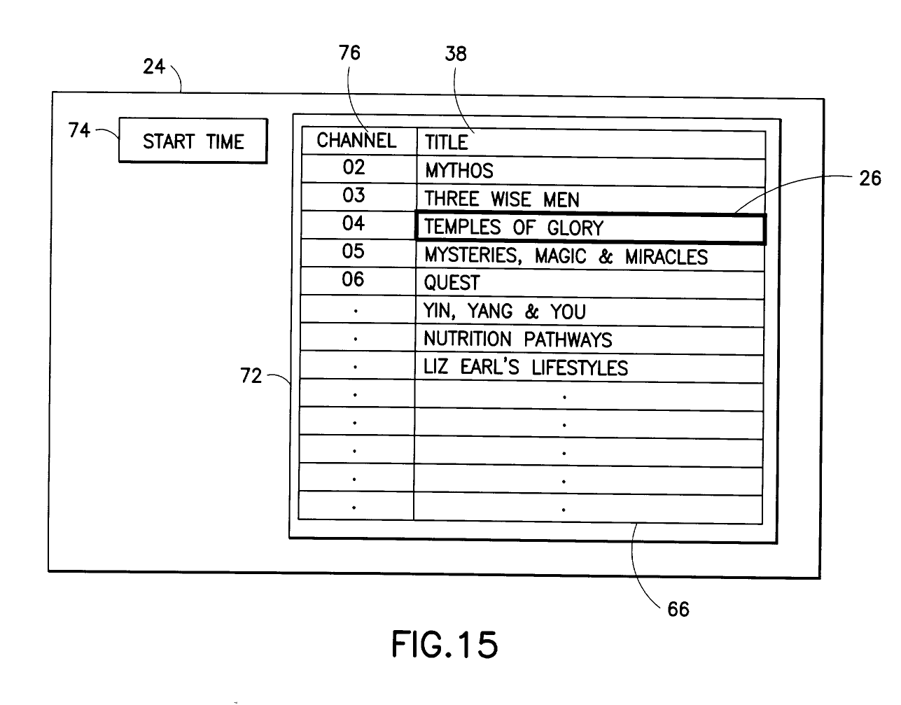

Referring now also to FIG. 14, a second type of first layer display window 68 of the multi-layer window display configuration of FIG. 13 is shown on a television display screen 24. In this embodiment, the first layer display window 68 comprises a window 70 for entering a time and/or a channel. The user can enter the time or channel into the set top box such as on a remote control or directly on the set top box 102. By entering a channel, the display could automatically switch to the second layer shown in FIG. 11. By entering a time, the display could automatically switch to the second layer shown in FIG. 15. The set top box 102 could be programmed to automatically determine if a time or a channel number has been entered. For example if the number entered is three digits or less, the STB 102 could automatically determine that the number entered is a channel number and not a time. Likewise, if the number entered is a four digit number, the STB 102 could automatically determine that the number entered is a time and not a channel number. However, this automatic determination might not be provided, such as when the window will only accept/recognize a time or a channel number; not both.

Once the user enters the time at the first layer display window 70, the display on the television screen 24 automatically switches to the second layer display windows 72, 74 as shown in FIG. 15. The first window 72 forms a window for displaying the sub-list 66. The second window 74 forms a window for displaying the start time entered in the first layer window 70. In an alternate embodiment, more or less display windows could be in the second layer.

The sub-list 66, in the embodiment shown, generally comprises two columns of information 38, 76. The first column 76 displays the channel numbers/indicia. The second column 38 displays titles 16 of broadcast programs for the channels shown in column 76. Also displayed on the window 72 is the cursor/highlighter 26. The cursor/highlighter 26 is adapted to vertically move up and down the column 38 of titles 16. When the cursor/highlighter 26 is located at a title, the user can select the title for viewing or other programming by pressing a selector button on the set top box 102 or a remote control. The cursor/highlighter 26, while in the window 72, is preferably adapted to only vertically move up and down along the column 38 of titles 16.

While these teachings have been particularly shown and described with respect to preferred embodiments thereof, it will be understood by those skilled in the art that changes in form and details may be made therein without departing from the scope and spirit of these teachings.

What is claimed is:

1. In a cable television system, an interactive entertainment guide presentation subsystem that comprises a head-end database storing programming information for a plurality of cable channels and an internet protocol-based Web browser function in each television set-top box (STB) for receiving and displaying the programming information in a list format, and for providing subscriber interactivity with the head-end via a bidirectional data link.

2. The system of claim 1, wherein an email functionality is provided for the subscriber.

3. The system of claim 1, wherein an Internet chat functionality is provided for the subscriber.

4. The system of claim 1, wherein the subscriber is provided access to a constrained set of Web pages using a walled garden technique.

5. The system of claim 1, wherein Web content is transcoded and stored at the head-end prior to being transmitted to the STB.

6. In a television interactive entertainment guide display system for displaying television channels, broadcast program titles, and broadcast times on a television display screen, the improvement comprising:
the system being adapted to display on the television display screen a vertically arranged list of the broadcast program titles, the list having only a single column of the titles organized and displayed adjacent respective associated broadcast times in a vertically arranged time sequence, wherein the list is limited to only a predetermined user selected channel.

7. A television interactive entertainment guide display system as in claim 6 wherein the system comprises a sequential two layer window display/selection system, a first one of the layers comprising a channel selection window being displayed on the television display screen.

8. A television interactive entertainment guide display system as in claim 7 wherein a subsequent second one of the layers comprises the list of the broadcast program titles being displayed on the television display screen corresponding to the channel selected at the first layer of the display/selection system.

9. A television interactive entertainment guide display system as in claim 7 wherein the channel selection window comprises a list of channels, and the system is adapted to move a cursor/highlighter to one of the displayed channels for selection of the channel.

10. A television interactive entertainment guide display system as in claim 7 wherein the channel selection window comprises a window for entering a channel number from a remote control.

11. A television interactive entertainment guide display system as in claim 6 wherein the system comprises a channel selection window being displayed on the television display screen when the list is displayed, the channel selection window comprises a window for entering a channel number from a remote control.

12. A television interactive entertainment guide display system as in claim 6 wherein the system comprises a remote control with a vertical only cursor movement key, wherein the vertical cursor movement key can be depressed to vertically move a cursor/highlighter along the column of the broadcast program titles.

13. In a television interactive entertainment guide display system for displaying television channels, broadcast program titles, and broadcast times on a television display screen, the improvement comprising:
the system being adapted to display a list of the television channels and subsequently display a first type of sub-list for a selected one of the channels, the first type of sub-list comprising a vertical column array of the broadcast program titles and associated ones of the broadcast times for the channel or, alternatively, the system being adapted to display a list of the broadcast times and subsequently display a second type of sub-list for a selected one of the broadcast times, the second type of sub-list comprising a vertical column array of the television channels and associated ones of the broadcast program titles, wherein the titles are displayed in only a single vertical column on the television display screen in a predetermined sequential order along the column.

14. A television interactive entertainment guide display system as in claim 13 wherein the channel selection window comprises a list of channels, and the system is adapted to move a cursor/highlighter to one of the displayed channels for selection of the channel.

15. A television interactive entertainment guide display system as in claim 13 wherein the system comprises a remote control with a vertical only cursor movement key, wherein the vertical cursor movement key can be depressed to vertically move a cursor/highlighter along the column of the broadcast program titles.

16. A method for selecting a broadcast television program, the program being broadcast based upon broadcast limitations comprising a broadcast channel and a broadcast time, the method comprising steps of:
entering a first one of the broadcast limitations into a broadcast television program selector;
upon entering the first broadcast limitation, displaying a list of a second one of the broadcast limitations, corresponding to the entered first broadcast limitation, in a vertical array on a screen of the television, the list being arranged adjacent a single column of program titles corresponding to the broadcast television programs for the vertically displayed second broadcast limitations and the entered first broadcast limitation; and
selecting one of the program titles in the single column of program titles by vertically moving a stepwise vertical only moving cursor/highlighter.

17. A method as in claim 16 wherein the step of entering a first one of the broadcast limitations comprises entering a broadcast channel into the selector.

18. A method as in claim 17 wherein the step of entering the broadcast channel into the selector comprises selecting the broadcast channel from a list of the broadcast channels.

19. A method as in claim 17 wherein the step of displaying a list of a second one of the broadcast limitations comprises displaying a list of the broadcast times corresponding to the entered broadcast channel.

20. A method as in claim 16 wherein the step of selecting one of the program titles comprises a user pressing a vertical only cursor movement button on a remote control to move the cursor/highlighter to a desired one of the program titles.
